(19) United States
(12) Patent Application Publication
(10) Pub. No.: US 2026/0128444 A1
(43) Pub. Date: May 7, 2026

(54) ASSEMBLY STRUCTURE OF BATTERY FRAME AND BATTERY PACKAGE INCLUDING THE SAME

(71) Applicant: SAMSUNG SDI CO., LTD., Yongin-si (KR)

(72) Inventor: KYOUNGSOO KIM, Yongin-si (KR)

(21) Appl. No.: 19/201,711

(22) Filed: May 7, 2025

(30) Foreign Application Priority Data
Nov. 7, 2024 (KR) 10-2024-0157079

(51) Int. Cl. H01M 50/262; H01M 50/244

(52) U.S. Cl. CPC H01M 50/262; H01M 50/244

(57) ABSTRACT

Provided are an assembly structure of a battery frame and a battery package including the same, in which assembly between frames may be easily and accurately performed. To this end, provided are an assembly structure of a battery frame and a battery package including the same, the assembly structure including a first boss portion that protrudes from a side edge of a first frame having a battery cell mounted therein and has an insertion hole portion in a direction of the side edge, a second boss portion that is arranged to correspond to the first boss portion on a second frame on which the first frame is seated, and that has a coupling hole portion corresponding to the insertion hole portion, and a fastening member having a shaft portion passing through the insertion hole portion and the coupling hole portion, an end portion of the shaft portion being fixed.

### CROSS-REFERENCE TO RELATED APPLICATION

The present application claims priority to Korean Patent Application No. 10-2024-0157079, filed on Nov. 7, 2024, in the Korean Intellectual Property Office, the entire disclosure of which is incorporated herein by reference.

### BACKGROUND

### 1. Field

One or more embodiments relate to an assembly structure of a battery frame and a battery package including the same, and more particularly, to an assembly structure of a battery frame that enables easy and accurate assembly between frames, and a battery package including the same.

### 2. Description of the Related Art

Unlike primary batteries that cannot be recharged, secondary batteries refer to batteries capable of charging and discharging, and are widely used in the field of electronic devices, including mobile phones, PDAs, laptop computers, tablet PCs, and the like.

In case that secondary batteries are installed in electronic devices such as laptop computers, these secondary batteries are generally fixed inside a cover frame of an electronic device in a state where a plurality of battery cells are mounted in a battery frame.

In this regard, the battery frame is fixed and assembled through a separate fixing member such as a fastening bolt while being seated in the cover frame of the electronic device.

Recently, as electronic devices become lighter and slimmer, battery cells are also becoming lighter and slimmer for the same capacity, resulting in a trend toward decreasing thickness.

However, in case that the battery frame is assembled with and fixed to the cover frame by using fastening bolts, it is necessary to form a fastening portion with sufficient thickness for the fastening bolts to be fastened.

Thus, there has been a difficulty in accommodating the trend toward slimmer batteries because it is difficult to reduce the thickness of the fastening portion above a reference value.

To improve this, in case that a double-sided tape is used instead of fastening bolts, due to a structure where the double-sided tape is hidden between a battery frame and a cover frame after assembly, damage to battery cells occurs when the battery frame is separated from the cover frame.

In case that an adhesive such as a double-sided tape is used, the thickness between the battery frame and the cover frame increases with the thickness of the adhesive, and attachment variation occurs from the change in size, leading to increased quality risks.

### SUMMARY

One or more embodiments include an assembly structure of a battery frame and a battery package including the same, the assembly structure enabling easy and accurate assembly between frames even in case that the thickness of a frame decreases in response to the slimming of battery cells.

Problems to be solved by the disclosure are not limited to the above-described problems, and other unmentioned problems and advantages of the disclosure can be understood by the following description and will be more clearly understood by embodiments of the disclosure. Also, it will be appreciated that the problems and advantages to be solved by the disclosure can be realized by the means and combinations thereof indicated in the claims.

According to one or more embodiments, an assembly structure of a battery frame includes a first boss portion protruding from a side edge of a first frame in which a battery cell is mounted and having an insertion hole portion formed in a direction of the side edge, a second boss portion arranged to correspond to the first boss portion on a second frame on which the first frame is seated, and having a coupling hole portion corresponding to the insertion hole portion, and a fastening member having a shaft portion passing through the insertion hole portion and the coupling hole portion, wherein an end portion of the shaft portion is fixed.

In an embodiment, the second boss portion may include a first fixing body that is in close contact with and supports the first boss portion and has a first coupling hole portion, and a second fixing body spaced apart from the first fixing body in an axial direction of the shaft portion and having a second coupling hole portion, wherein a cut section may be formed between the first fixing body and the second fixing body, the cut section exposing a portion of the shaft portion to an outside.

In an embodiment, the first boss portion may include a first support body that is arranged in the cut section, has a first insertion hole portion, and is in close contact with the first fixing body, and a second support body that is arranged in the cut section, has a second insertion hole portion, and is in close contact with the second fixing body.

In an embodiment, a distance between the first support body and the second support body may be set to a size of 1 to 2 times a diameter of the shaft portion.

In an embodiment, an outer side surface of the second fixing body may be inclined downward, an end portion of the shaft portion being fixed to the outer side surface of the second fixing body.

In an embodiment, an angle between the outer side surface and a surface of the second frame on which the first frame is seated may be set to 45 degrees or more.

In an embodiment, a height of the first boss portion may be set to a size of 2 to 3 times a diameter of the shaft portion.

In an embodiment, a protrusion length of the first boss portion may be set to a size of 2 to 3 times a diameter of the shaft portion.

In an embodiment, the second boss portion may include a first fixing body that is in close contact with and supports one side surface of the first boss portion, a second fixing body that is in close contact with and supports another side surface of the first boss portion, and a third fixing body spaced apart from the second fixing body in an axial direction of the shaft portion, wherein a cut section may be formed between the second fixing body and the third fixing body, the cut section exposing a portion of the shaft portion to an outside.

In an embodiment, a distance between the second fixing body and the third fixing body may be set to 2 times or less a diameter of the shaft portion.

According to one or more embodiments, a battery package includes at least one battery cell, a first frame having the at least one battery cell mounted therein and including a first boss portion protruding from a side edge thereof, the first boss portion having an insertion hole portion formed in a direction of the side edge, and a second frame on which the first frame is seated and which includes a second boss portion corresponding to the first boss portion, the second boss portion having a coupling hole portion formed to correspond to the insertion hole portion, wherein a shaft portion of a fastening member may pass through the insertion hole portion and the coupling hole portion and an end portion of the shaft portion may be fixed, to assemble the first frame to the second frame.

In an embodiment, the second boss portion may include a first fixing body that is in close contact with and supports the first boss portion and has a first coupling hole portion, and a second fixing body spaced apart from the first fixing body in an axial direction of the shaft portion and having a second coupling hole portion, wherein a cut section may be formed between the first fixing body and the second fixing body, the cut section exposing a portion of the shaft portion to an outside.

In an embodiment, the first boss portion may include a first support body that is arranged in the cut section, has a first insertion hole portion, and is in close contact with the first fixing body, and a second support body that is arranged in the cut section, has a second insertion hole portion, and is in close contact with the second fixing body.

In an embodiment, a distance between the first support body and the second support body may be set to a size of 1 to 2 times a diameter of the shaft portion.

In an embodiment, an outer side surface of the second fixing body may be inclined downward, an end portion of the shaft portion being fixed to the outer side surface of the second fixing body.

In an embodiment, an angle between the outer side surface and a surface of the second frame on which the first frame is seated may be set to 45 degrees or more.

In an embodiment, a height of the first boss portion may be set to a size of 2 to 3 times a diameter of the shaft portion.

In an embodiment, a protrusion length of the first boss portion may be set to a size of 2 to 3 times a diameter of the shaft portion.

In an embodiment, the second boss portion may include a first fixing body that is in close contact with and supports one side surface of the first boss portion, a second fixing body that is in close contact with and supports another side surface of the first boss portion, and a third fixing body spaced apart from the second fixing body in an axial direction of the shaft portion, wherein a cut section may be formed between the second fixing body and the third fixing body, the cut section exposing a portion of the shaft portion to an outside.

In an embodiment, a distance between the second fixing body and the third fixing body may be set to 2 times or less a diameter of the shaft portion.

### BRIEF DESCRIPTION OF THE DRAWINGS

The accompanying drawings illustrate example embodiments of the disclosure and, together with the detailed description of the disclosure, which will be provided below, serve to provide further understanding of the technical spirit of the disclosure. However, the disclosure is not to be construed as being limited to the matters described in the drawings in which:

FIG. 1 is an exploded perspective view of an assembly structure of a battery frame and a battery package including the same, according to an embodiment;

FIG. 2 is an assembly perspective view of FIG. 1;

FIG. 3 is an assembly cross-sectional view illustrating the main components of an assembly structure of a battery frame, according to an embodiment;

FIGS. 4A to 4D are views illustrating an assembly process for a battery frame, according to an embodiment;

FIGS. 5A to 5D are views illustrating an assembly process for a battery frame, according to another embodiment; and

FIG. 6 is an assembly cross-sectional view illustrating the main components of an assembly structure of a battery frame, according to another embodiment.

### DETAILED DESCRIPTION

Hereinafter, example embodiments of the disclosure will be described in detail with reference to the accompanying drawings. The terms or words used in the specification and the claims should not be construed as being limited to ordinary or dictionary meanings and should be construed as meanings and concepts consistent with the spirit of the disclosure based on a principle that an inventor can appropriately define concepts of terms to explain his/her invention in the best way. Therefore, it should be understood that the embodiments described herein and the configurations illustrated in the drawings are merely some of the example embodiments of the disclosure and do not represent all technical ideas of the disclosure, and thus various equivalents and modifications that can replace these embodiments can be made at the time of filing this application.

Also, the terms “include (comprise)” and/or “including (comprising)” as used herein specify the presence of the stated shapes, numbers, steps, operations, members, elements, and/or groups thereof and do not preclude the presence or addition of one or more other shapes, numbers, operations, members, elements, and/or groups thereof.

To help understand the disclosure, the accompanying drawings are not shown to actual scale, and the dimensions of some components may be exaggerated. Also, like reference numerals may refer to like elements in different embodiments.

The expression indicating that two comparative objects are identical to each other means that the two comparative objects are “substantially identical” to each other. Therefore, the wording “substantially identical” may include deviations considered low in the art, for example, deviations within 5%. A case where a parameter is uniform in a certain region may mean that the parameter is uniform from an average point of view.

It will be understood that, although the terms “first,” “second,” and the like may be used herein to describe various elements, but these elements should not be limited by these terms. There terms are only used to distinguish one element from another element, and a first element may also be a second element, unless otherwise specifically stated herein.

Throughout the specification, each element may be singular or plural unless otherwise specifically stated herein.

It well be understood that, in case that an element is referred to as being “above (or below)” or “on (or under)” another element, the element can be directly on an upper surface (or lower surface) of the other element, and it may also mean that there are other intervening elements between the element and the other element disposed on (or under) the element.

It will be understood that, in case that an element is referred to as being “connected,” “coupled,” or “linked” to another element, the element can be directly connected or linked to the other element, and other elements are “interposed” between the element and the other element, or the element may be “connected,” “coupled,” or “linked” to the other element via other elements. In case that a portion is referred to as being electrically coupled to another portion, it includes not only a case where the portion is directly connected to the other portion, but also a case where the portion is connected to the other portion with other components present therebetween.

Throughout the specification, “A and/or B” means “A, or B, or A and B,” unless otherwise specifically stated herein. The term “and/or” includes any or all combinations of a plurality of listed items. Unless otherwise specifically stated herein, the expression “C to D” means greater than or equal to C and less than or equal to D.

The terms used herein are to describe embodiments of the disclosure and are not intended to limit the disclosure.

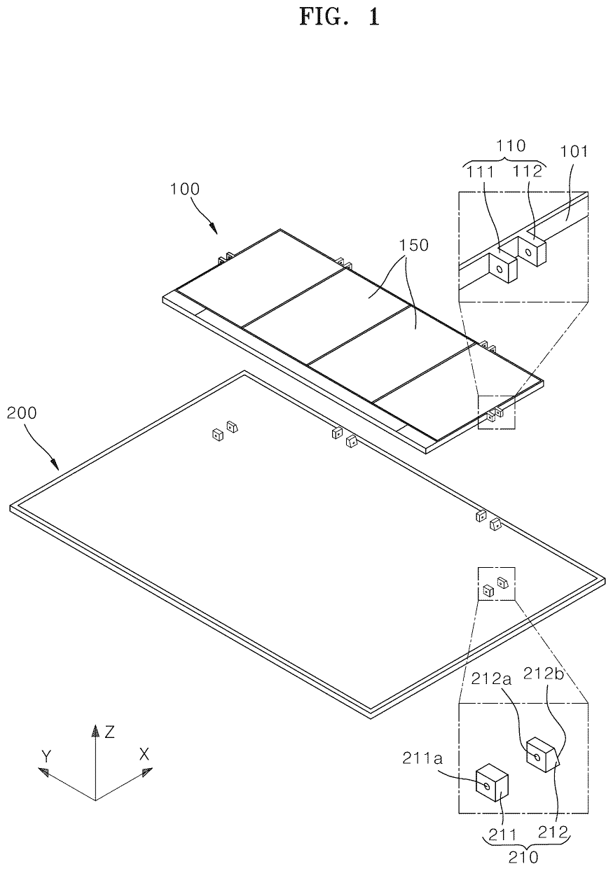

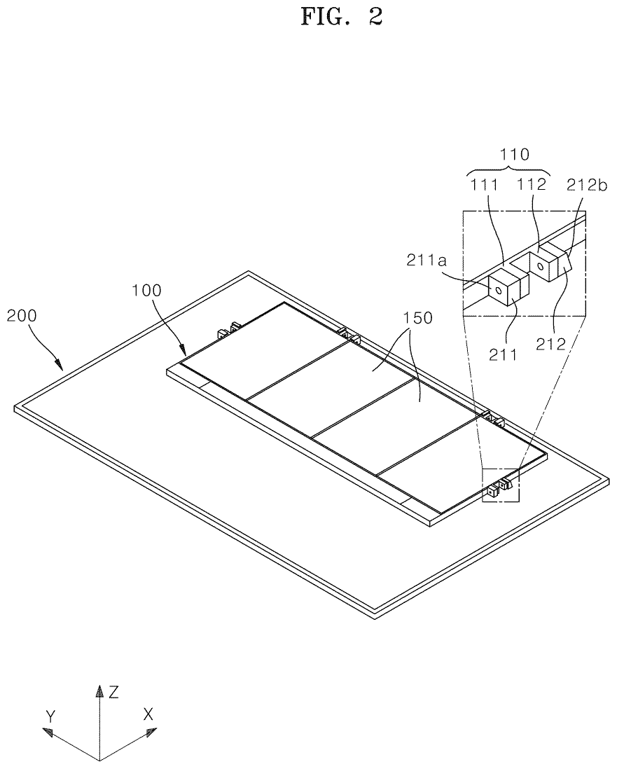

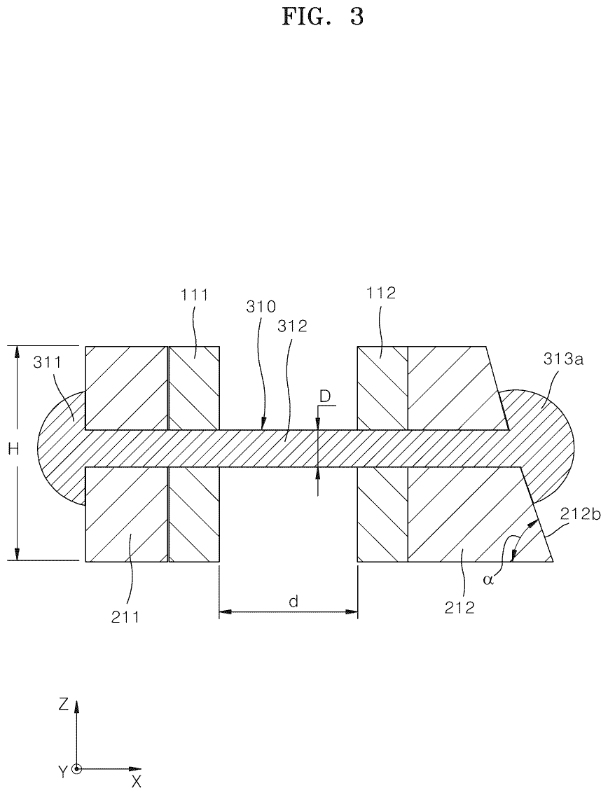

FIG. 1 is an exploded perspective view of an assembly structure of a battery frame and a battery package 1 including the same, according to an embodiment. FIG. 2 is an assembly perspective view of FIG. 1. FIG. 3 is an assembly cross-sectional view illustrating the main components of an assembly structure of a battery frame, according to an embodiment.

Referring to FIGS. 1 and 2, the battery package 1 according to an embodiment of the disclosure is a package including an assembly structure of a battery frame, according to an embodiment of the disclosure and may include a first frame 100, a plurality of battery cells 150 arranged in the first frame 100, and a second frame 200 on and to which the first frame 100 is seated and assembled.

The battery package 1 according to an embodiment of the disclosure may include a structure in which the first frame 100, which is a battery frame having the plurality of battery cells 150 mounted therein, is assembled to the second frame 200, which is a set frame of an electronic device.

The battery package 1 according to an embodiment of the disclosure may also refer to an electronic device, such as a notebook computer, assembled using the assembly structure according to an embodiment of the disclosure.

Referring to FIGS. 1 to 3, the assembly structure of the battery frame, according to an embodiment of the disclosure, is a structure in which the first frame 100 having the plurality of battery cells 150 mounted therein is seated on and assembled to the second frame 200.

The assembly structure of the battery frame, according to an embodiment of the disclosure, may include a first boss portion 110 provided on the first frame 100, a second boss portion 210 provided on the second frame 200, and a fastening member 310 coupled to the first boss portion 110 and the second boss portion 210.

The assembly structure of the battery frame, according to an embodiment, is an assembly structure in which the first frame 100 is seated on an inner surface of the second frame 200 in a vertical direction (Z-axis direction of FIG. 1), and then the fastening member 310 is coupled to the first boss portion 110 and the second boss portion 210 in a horizontal direction (X-axis direction or Y-axis direction of FIG. 1).

For example, the assembly structure of the battery frame, according to an embodiment, is not a structure in which the fastening member 310 is coupled in a vertical direction (Z-axis direction of FIG. 1), which is a thickness direction (Z-axis direction of FIG. 1) of the first frame 100 and the second frame 200, but is a structure in which the fastening member 310 is coupled in a horizontal direction (X-axis direction or Y-axis direction of FIG. 1) perpendicular to the thickness direction.

Thus, the assembly structure of the battery frame, according to an embodiment, may minimize the thickness of the first frame 100 and the second frame 200, and accordingly may accommodate the slimming of the battery cells 150.

In the assembly structure of the battery frame, according to an embodiment of the disclosure, in case that the fastening member 310 is coupled to the first boss portion 110 and the second boss portion 210, a portion of a shaft portion 312 of the fastening member 310 may be exposed.

Thus, in the assembly structure of the battery frame, according to an embodiment, in case that the first frame 100 is separated from the second frame 200 after assembly, the exposed portion of the shaft portion 312 of the fastening member 310 may be cut, thereby enabling simple disassembly, and thus man-hours for separation work may be reduced, resulting in improved separation workability.

In an embodiment, the first frame 100 may be a battery frame in which the plurality of battery cells 150 are mounted, and the second frame 200 may be a set frame of an electronic device, such as a notebook computer, using the plurality of battery cells 150 as a power source.

In an embodiment, first boss portions 110 may be provided on at least opposite sides, among side edges 101, of the first frame 100, and a plurality of second boss portions 210 may be provided at positions of the second frame 200 which correspond to the first boss portions 110.

As such, the assembly structure of the battery frame, according to an embodiment of the disclosure, may be arranged in a plurality of positions in a horizontal direction (X-axis direction or Y-axis direction of FIG. 1), but these structures have the same configuration while differing only in arrangement positions and directions. Thus, in the following description, an assembly structure arranged on one side edge 101 in a horizontal direction (X-axis direction of FIG. 1), among the side edges 101, of the first frame 100 will be described as an example for convenience.

In other embodiments, in the assembly structure of the battery frame, according to an embodiment of the disclosure, various members may be applied as the fastening member 310 such that the shaft portion 312 passes through the first boss portion 110 and the second boss portion 210, and in a state where a head portion 311 is supported by the first boss portion 110, an end portion 313 is fixed to an outer side surface 212b of the second boss portion 210.

For example, the fastening member 310 may be a bolt or a rivet.

As an example, in case that a bolt is applied, an end portion of the bolt may be fastened with a nut on the outer side surface 212b of the second boss portion 210 to be fixed in position.

As another example, in case that a rivet is applied, an end portion of the rivet may be press-fitted and fixed by riveting onto the outer side surface 212b of the second boss portion 210. The end portion of the rivet may also be fixed by a method such as welding.

In the following description, a case where a rivet is applied as the fastening member 310 will be described as an example for convenience, and the fastening member 310 will be collectively referred to as a rivet.

Referring to FIGS. 1 to 3, in an embodiment, the first boss portion 110 may protrude from the side edge 101 of the first frame 100 in a horizontal direction (Y-axis direction of FIG. 1).

In an embodiment, the first boss portion 110 may be formed as a pair including a first support body 111 and a second support body 112 that are spaced apart from each other in a direction (X-axis direction of FIG. 1) of the side edge 101 of the first frame 100.

The first support body 111 and the second support body 112 of the first boss portion 110 may protrude from the side edge 101 of the first boss portion 110 in a lateral direction (Y-axis direction of FIG. 1) to have a certain length L.

Although it is illustrated that the first support body 111 and the second support body 112 protrude to the same length, the disclosure is not limited thereto, and the first support body 111 and the second support body 112 may also protrude to different lengths.

A protrusion length L of the first support body 111 and the second support body 112 may be set to a size of 2 to 3 times a diameter D of the shaft portion 312 of the rivet 310.

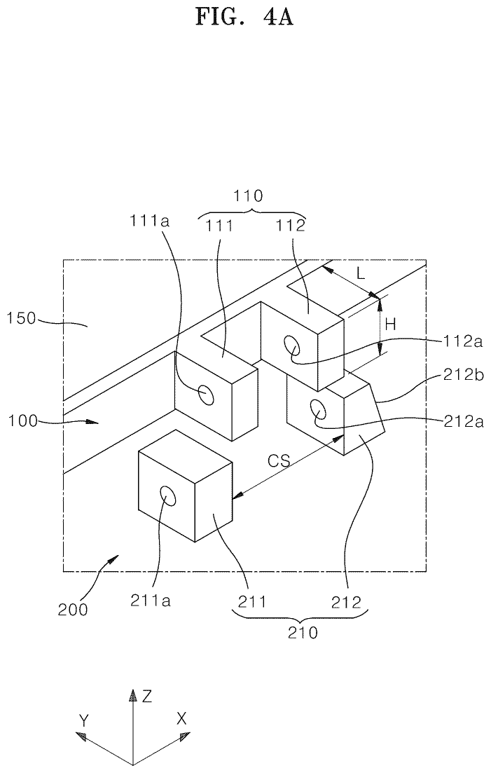

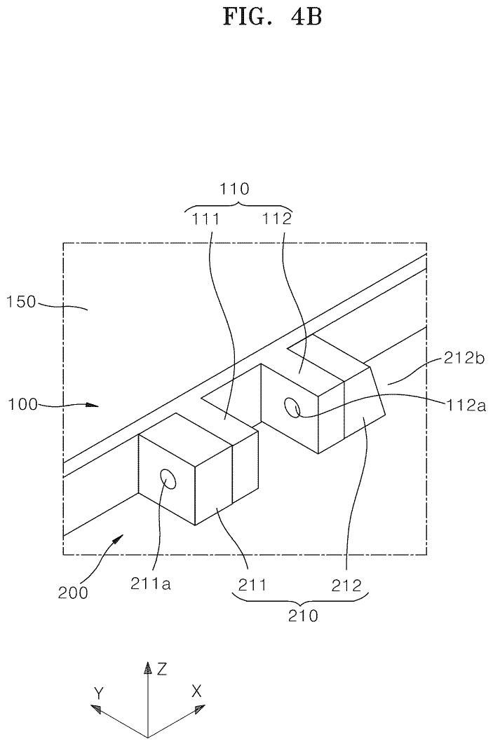

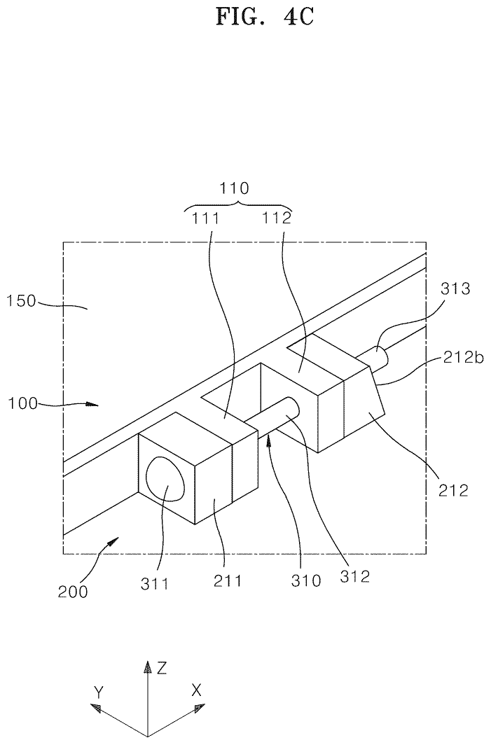

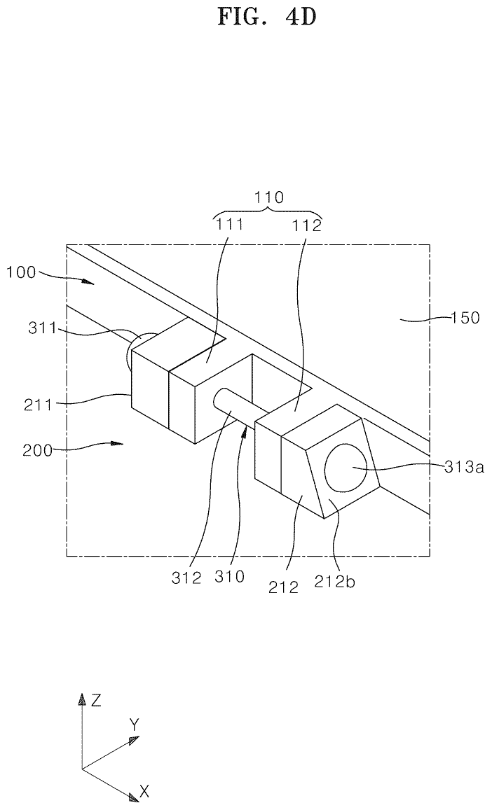

In other embodiments, a height H in a vertical direction (Z-axis direction of FIG. 4) of the first support body 111 and the second support body 112 may be set to a size of 2 to 3 times the diameter D of the shaft portion 312 of the rivet 310.

For example, in case that the rivet 310 is coupled to the first boss portion 110, a force that compresses the first support body 111 and the second support body 112 is generated in an axial direction (X-axis direction of FIG. 4) of the shaft portion 312.

In this regard, the protrusion length L and the height H of the first support body 111 and the second support body 112 must be set to at least twice the diameter D of the shaft portion 312 of the rivet 310. This is because a pressure acting on the first support body 111 and the second support body 112 may be sufficiently distributed and the load may be effectively supported.

In case that the protrusion length L and the height H of the first support body 111 and the second support body 112 are set to exceed 3 times the diameter D of the shaft portion 312 of the rivet 310, the load distribution effect of the first support body 111 and the second support body 112 may increase, but manufacturing complexity and manufacturing costs may increase, and an unnecessary increase in volume may cause limitations in an assembly space.

The first support body 111 and the second support body 112 of the first boss portion 110 may have a rectangular shape to be stably seated on the second frame 200 and be in close contact with the second boss portion 210.

A first insertion hole portion 111a and a second insertion hole portion 112a may be formed in the first support body 111 and the second support body 112, respectively, of the first boss portion 110 in a direction (X-axis direction of FIG. 1) of the side edge 101 of the first frame 100.

The shaft portion 312 of the rivet 310 may pass through the first insertion hole portion 111a of the first support body 111 and the second insertion hole portion 112a of the second support body 112 in case that the first boss portion 110 is assembled to the second boss portion 210.

Referring to FIGS. 1 to 3, in an embodiment, the second boss portion 210 may be arranged to correspond to the first boss portion 110 on the second frame 200 on which the first frame 100 is seated.

In an embodiment, the second boss portion 210 may include a first fixing body 211 that is in close contact with and supports the first support body 111 of the first boss portion 110 and a second fixing body 212 that is in close contact with and supports the second support body 112 of the first boss portion 110.

The second fixing body 212 of the second boss portion 210 may be spaced apart from the first fixing body 211 of the second boss portion 210 in an axial direction (X-axis direction of FIG. 4) of the shaft portion 312 of the rivet 310. In this regard, a cut section CS, which is a space through which the shaft portion 312 of the rivet 310 is exposed, may be formed between the first fixing body 211 and the second fixing body 212.

For example, the first support body 111 and the second support body 112 of the first boss portion 110 may be arranged in the cut section CS formed between the first fixing body 211 and the second fixing body 212 of the second boss portion 210.

For example, in case that the first support body 111 and the second support body 112 are arranged in the cut section CS, the first support body 111 may be in close contact with the first fixing body 211 and the second support body 112 may be in close contact with the second fixing body 212.

Thus, in case in that the first support body 111 and the second support body 112 are arranged in the cut section CS, a portion of the shaft portion 312 of the rivet 310 may be exposed through the space between the first support body 111 and the second support body 112.

Therefore, after assembling the first frame 100 and the second frame 200, in case that the exposed portion of the shaft portion 312 is cut and the rivet 310 is removed, the first frame 100 may be separated from the second frame 200, thus being in a disassembled state.

In this regard, a distance d between the first support body 111 and the second support body 112 may be set to 1 to 2 times the diameter D of the shaft portion 312 of the rivet 310.

In case that the distance d between the first support body 111 and the second support body 112 is smaller than the diameter D of the shaft portion 312, it is difficult to cut the exposed portion of the shaft portion 312.

In other embodiments, in case that the distance d between the first support body 111 and the second support body 112 exceeds twice the diameter D of the shaft portion 312, if the head portion 311 of the rivet 310 is pressed or the end portion 313 of the shaft portion 312 is riveted, defects, such as bending of or damage to the exposed portion of the shaft portion 312, may occur.

The first fixing body 211 and the second fixing body 212 of the second boss portion 210 may have a rectangular shape to correspond to the first support body 111 and the second support body 112 of the first boss portion 110.

A first coupling hole portion 211a and a second coupling hole portion 212a may be formed in the first fixing body 211 and the second fixing body 212, respectively, of the second boss portion 210 in a direction (X-axis direction of FIG. 1) of the side edge 101 of the first frame 100.

In case that the first boss portion 110 is assembled to the second boss portion 210, the shaft portion 312 of the rivet 310 may pass through the first coupling hole portion 211a of the first fixing body 211 and the second coupling hole portion 212a of the second fixing body 212.

Referring to FIG. 3, an outer side surface 212b, which is a coupling surface to which the end portion 313 of the shaft portion 312 of the rivet 310 is riveted, may be formed on an outer side (right side in an X-axis direction of FIG. 3) of the second fixing body 212.

The outer side surface 212b of the second fixing body 212 is a portion where the end portion 313 of the shaft portion 312 of the rivet 310 is riveted to form a riveted portion 313a having a shape similar to the head portion 311.

The outer side surface 212b of the second fixing body 212 may be inclined downward in a direction (X-axis direction of FIG. 3) in which the shaft portion 312 of the rivet 310 passes.

In this regard, an angle α between the outer side surface 212b of the second fixing body 212 and a surface of the second frame 200 on which the first frame 100 is seated may be 45 degrees or more.

In case that the angle α between the outer side surface 212b of the second fixing body 212 and the surface of the second frame 200 is less than 45 degrees, the riveted portion 313a may undergo shear fracture because a force acting in a vertical direction (Z-axis direction of FIG. 3) is greater than a force acting in the axial direction (X-axis direction of FIG. 3) of the shaft portion 312.

Therefore, the angle α between the outer side surface 212b of the second fixing body 212 and the surface of the second frame 200 may be set to 45 degrees or more, so that the force acting on the riveted portion 313a in the axial direction (X-axis direction of FIG. 3) of the shaft portion 312 is greater than the force acting on the riveted portion 313a in the vertical direction (Z-axis direction of FIG. 3).

Hereinafter, an assembly process for a battery frame, according to an embodiment of the disclosure, will be described in further detail with reference to the accompanying drawings.

FIGS. 4A to 4D are views illustrating an assembly process for a battery frame, according to an embodiment.

Referring to FIG. 4A, the first frame 100 may be arranged on the second frame 200 so that the first boss portion 110 is positioned on the second boss portion 210.

In this regard, the first support body 111 and the second support body 112 of the first boss portion 110 may be positioned between the first fixing body 211 and the second fixing body 212 of the second boss portion 210.

The first insertion hole portion 111a and the second insertion hole portion 112a may be formed in the first support body 111 and the second support body 112, respectively, of the first boss portion 110 in a direction (X-axis direction) of the side edge 101 of the first frame 100.

In this regard, the first insertion hole portion 111a and the second insertion hole portion 112a may be positioned in a straight line in the axial direction (X-axis direction) of the shaft portion 312 so that the shaft portion 312 (see FIG. 3C) of the rivet 310 (see FIG. 3C) passes through the first insertion hole portion 111a and the second insertion hole portion 112a.

The first coupling hole portion 211a and the second coupling hole portion 212a may be formed in the first fixing body 211 and the second fixing body 212, respectively, of the second boss portion 210 in a direction (X-axis direction) of the side edge 101 of the first frame 100.

In this regard, the first coupling hole portion 211a and the second coupling hole portion 212a may also be positioned in a straight line in the axial direction (X-axis direction) of the shaft portion 312 so that the shaft portion 312 (see FIG. 3C) of the rivet 310 (see FIG. 3C) passes through the first coupling hole portion 211a and the second coupling hole portion 212a.

Referring to FIG. 4B, the first frame 100 in which the battery cells 150 are mounted may be seated on the second frame 200 in a vertical direction (Z-axis direction).

In this regard, the first support body 111 of the first boss portion 110 may be in close contact with the first fixing body 211 of the second boss portion 210, and the second support body 112 of the first boss portion 110 may be in close contact with the second fixing body 212 of the second boss portion 210.

In this state, the first insertion hole portion 111a of the first support body 111 may be in communication with the first coupling hole portion 211a of the first fixing body 211, and the second insertion hole portion 112a of the second support body 112 may be in communication with the second coupling hole portion 212a of the second fixing body 212.

In other embodiments, the first support body 111 and the second support body 112 may be arranged between the first fixing body 211 and the second fixing body 212, and thereafter, a space through which the shaft portion 312 (see FIG. 4C) of the rivet 310 (see FIG. 4C) is exposed may be provided between the first support body 111 and the second support body 112.

Referring to FIG. 4C, the shaft portion 312 of the rivet 310 may be sequentially inserted into the first coupling hole portion 211a of the first fixing body 211, the first insertion hole portion 111a of the first support body 111, the second insertion hole portion 112a of the second support body 112, and the second coupling hole portion 212a of the second fixing body 212.

In this regard, the head portion 311 of the rivet 310 may be seated and supported on the outer side surface of the first fixing body 211, and the end portion 313 of the shaft portion 312 of the rivet 310 may protrude outward from the outer side surface 212b of the second fixing body 212.

The outer side surface 212b of the second fixing body 212 may be inclined downward in a direction (X-axis direction of FIG. 3) in which the shaft portion 312 of the rivet 310 passes, and an angle α between the outer side surface 212b of the second fixing body 212 and a surface of the second frame 200 on which the first frame 100 is seated may be 45 degrees or more.

Referring to FIG. 4D, the first boss portion 110 may be fixed to the second boss portion 210 by riveting the end portion 313 of the shaft portion 312 of the rivet 310, the end portion 313 protruding outward from the outer side surface 212b of the second fixing body 212.

In this regard, the end portion 313 of the shaft portion 312 of the rivet 310 may be riveted to form a riveted portion 313a having a shape similar to the head portion 311, and a portion of the shaft portion 312 of the rivet 310 may be exposed through the space between the first support body 111 and the second support body 112 of the first boss portion 110.

Therefore, after assembling the first frame 100 and the second frame 200, in case that the exposed portion of the shaft portion 312 is cut and the rivet 310 is removed, the first frame 100 may be separated from the second frame 200, thus being in a disassembled state.

Next, an assembly structure of a battery frame, according to another embodiment of the disclosure, will be described with reference to the accompanying drawings.

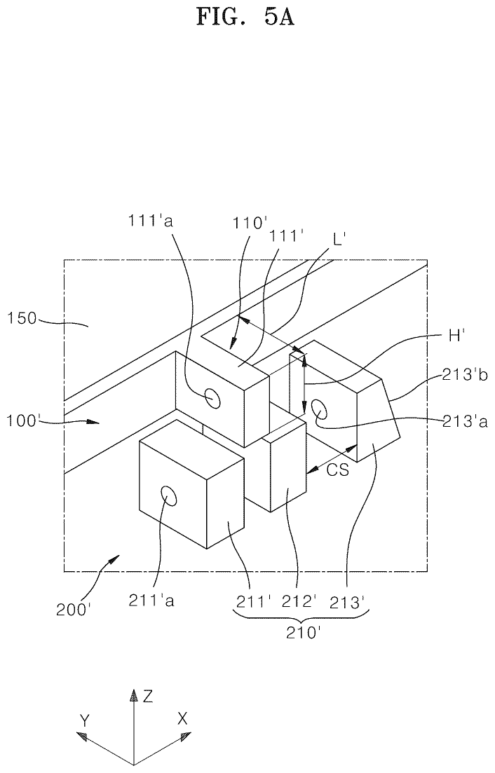

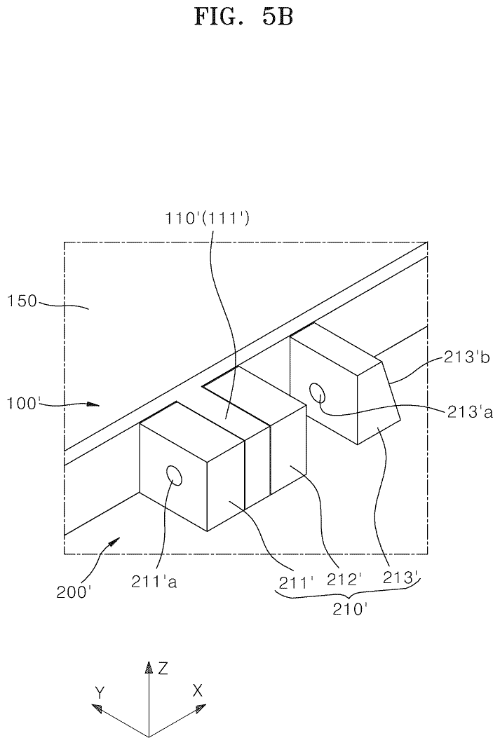

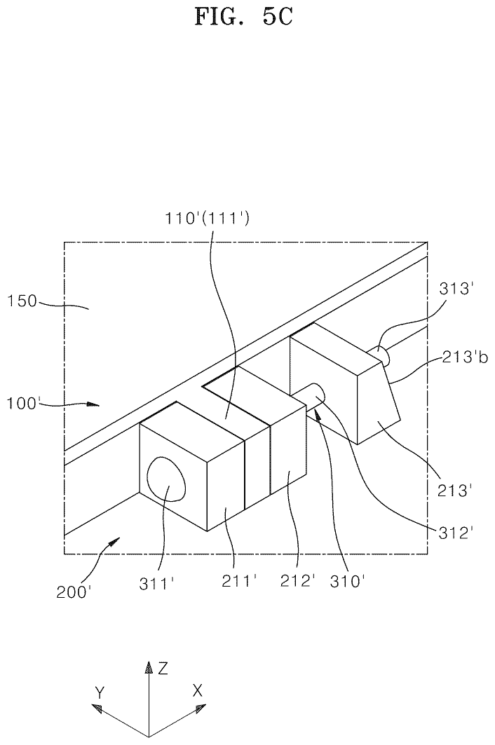

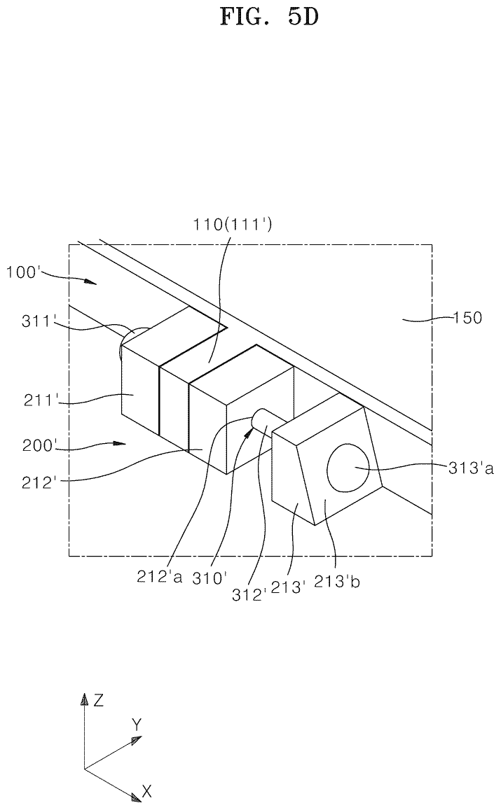

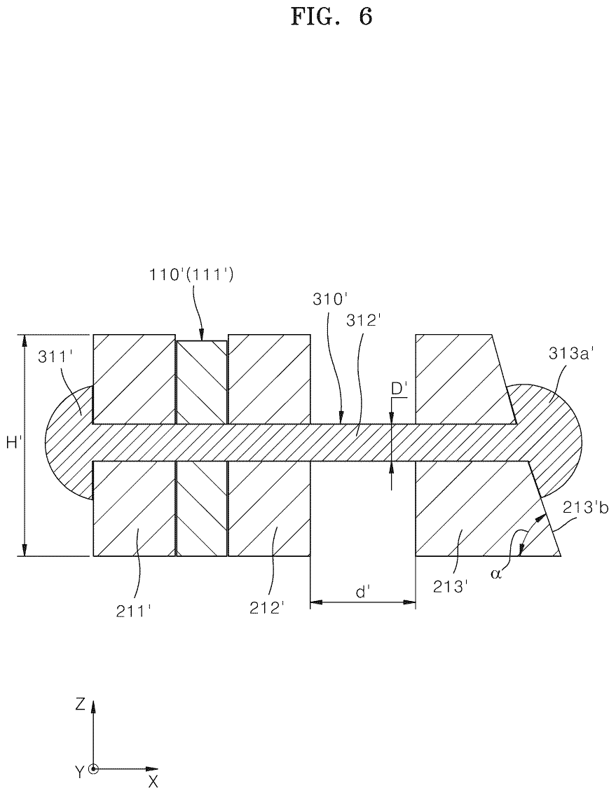

FIGS. 5A to 5D are views illustrating an assembly process for a battery frame, according to another embodiment. FIG. 6 is an assembly cross-sectional view illustrating the main components of an assembly structure of a battery frame, according to another embodiment.

Referring to FIGS. 5A to 6, the assembly structure of the battery frame, according to another embodiment of the disclosure, is a structure in which, similar to the above-described embodiment, a first frame 100′ in which the battery cells 150 are mounted is seated on and assembled to a second frame 200′ of an electronic device.

The assembly structure of the battery frame, according to another embodiment of the disclosure, may include a first boss portion 110′ provided on the first frame 100′, a second boss portion 210′provided on the second frame 200′, and a rivet 310′ coupled to the first boss portion 110′ and the second boss portion 210′.

The assembly structure of a battery frame, according to an embodiment, may be an assembly structure in which the first frame 100′ is seated on an inner surface of the second frame 200′ in a vertical direction (Z-axis direction of FIG. 5A), and then the rivet 310′ is coupled to the first boss portion 110′ and the second boss portion 210′ in a horizontal direction (X-axis direction or Y-axis direction of FIG. 5A).

For example, the assembly structure of the battery frame, according to an embodiment, is not a structure in which a fastening member is coupled in a vertical direction (Z-axis direction of FIG. 5A), which is a thickness direction (Z-axis direction of FIG. 5A) of the first frame 100′ and the second frame 200′, but is a structure in which a fastening member is coupled in a horizontal direction (X-axis direction or Y-axis direction of FIG. 5A) perpendicular to the thickness direction.

Thus, the assembly structure of the battery frame, according to an embodiment, may minimize the thickness of the first frame 100′ and the second frame 200′, and accordingly may accommodate the slimming of the battery cells 150.

In the assembly structure of the battery frame, according to another embodiment of the disclosure, in case that the rivet 310′ is coupled to the first boss portion 110′ and the second boss portion 210′, a portion of a shaft portion 312′ of the rivet 310′ may be exposed.

Thus, in the assembly structure of the battery frame, according to an embodiment, in case that the first frame 100′ is separated from the second frame 200′ after assembly, the exposed portion of the shaft portion 312′ of the rivet 310′ may be cut, thereby enabling simple disassembly, and thus man-hours for separation work may be reduced, resulting in improved separation workability.

In another embodiment of the disclosure, the first frame 100′ may be a battery frame in which the plurality of battery cells 150 are mounted, and the second frame 200′ may be a cover frame of an electronic device, such as a notebook computer, using the plurality of battery cells 150 as a power source.

In an embodiment, first boss portions 110′ may be provided on at least opposite sides, among side edges, of the first frame 100′, and a plurality of second boss portions 210′ may be provided at positions of the second frame 200′ which correspond to the first boss portions 110′.

As such, the assembly structure of the battery frame, according to another embodiment of the disclosure, may be arranged in a plurality of positions in a horizontal direction (X-axis direction or Y-axis direction of FIG. 5A), but these structures have the same configuration while differing only in arrangement positions and directions. Thus, in the following description, an assembly structure arranged on one side edge in a horizontal direction (X-axis direction of FIG. 5A), among the side edges, of the first frame 100′ will be described as an example for convenience.

Referring to FIGS. 5A to 6, in another embodiment, the first boss portion 110′ may protrude from a side edge of the first frame 100′ in a horizontal direction (Y-axis direction of FIG. 5A).

In an embodiment, the first boss portion 110′ may include a single support body 111′ protruding from a side edge of the first frame 100.

The support body 111′ may protrude from the side edge of the first frame 100′ to have a certain length L in a lateral direction (Y-axis direction of FIG. 5A).

A protrusion length L of the support body 111′ may be set to a size of 2 to 3 times a diameter D′ of the shaft portion 312′ of the rivet 310′.

In other embodiments, a height H′ in a vertical direction (Z-axis direction of FIG. 6) of the support body 111′ may be set to a size of 2 to 3 times the diameter D′ of the shaft portion 312′ of the rivet 310′.

For example, in case that the rivet 310′ is coupled to the support body 111′ of the first boss portion 110′, a force that compresses the support body 111′ is generated in an axial direction (X-axis direction of FIG. 6) of the shaft portion 312′.

In this regard, the protrusion length L and the height H′ of the support body 111′ must be set to at least twice the diameter D′ of the shaft portion 312′ of the rivet 310′. This is because a pressure acting on the support body 111′ may be sufficiently distributed and the load may be effectively supported.

In case that the protrusion length L and the height H′ of the support body 111′ exceeds 3 times the diameter D′ of the shaft portion 312′ of the rivet 310′, the load distribution effect of the support body 111′ may increase, but manufacturing complexity and manufacturing costs may increase, and an unnecessary increase in volume may cause limitations in an assembly space.

The support body 111′ of the first boss portion 110′ may have a rectangular shape to be stably seated on the second frame 200′ and be in close contact with the second boss portion 210′.

An insertion hole portion 111′a may be formed in the support body 111′ of the first boss portion 110′ in a direction (X-axis direction of FIG. 5A) of a side edge of the first frame 100′.

The shaft portion 312′ of the rivet 310′ may pass through the first insertion hole portion 111′a of the support body 111′ in case that the first boss portion 110′ is assembled to the second boss portion 210′.

Referring to FIGS. 5A to 6, in another embodiment, the second boss portion 210′ may be arranged to correspond to the first boss portion 110′ on the second frame 200′ on which the first frame 100′ is seated.

In an embodiment, the second boss portion 210′ may include a first fixing body 211′ that is in close contact with and supports one side surface of the support body 111′ of the first boss portion 110′, a second fixing body 212′ that is in close contact with and supports another side surface of the support body 111′, and a third fixing body 213′ spaced apart from the second fixing body 212′ in a horizontal direction (X-axis direction of FIG. 5A).

Because the third fixing body 213′ of the second boss portion 210′ is spaced apart from the second fixing body 212′, a cut section CS, which is a space through which the shaft portion 312′ of the rivet 310′ is exposed, may be formed between the third fixing body 213′ and the second fixing body 212′.

For example, in case that the support body 111′ of the first boss portion 110′ is inserted between the first fixing body 211′ and the second fixing body 212′ of the second boss portion 210′, a cut section CS through which a portion of the shaft portion 312′ of the rivet 310′ is exposed may be formed between the second fixing body 212′ and the third fixing body 213′ of the second boss portion 210′.

Therefore, after assembling the first frame 100′ and the second frame 200′, in case that the exposed portion of the shaft portion 312′ is cut and the rivet 310′ is removed, the first frame 100′ may be separated from the second frame 200′, thus being in a disassembled state.

In this regard, a distance d′ between the second fixing body 212′ and the third fixing body 213′ may be set to 1 to 2 times or less the diameter D′ of the shaft portion 312′ of the rivet 310′.

In case that the distance d′ between the second fixing body 212′ and the third fixing body 213′ is less than the diameter D′ of the shaft portion 312′, it is difficult to cut the exposed portion of the shaft portion 312′.

In case that the distance d′ between the second fixing body 212′ and the third fixing body 213′ exceeds twice the diameter D′ of the shaft portion 312′, if the head portion 311′ of the rivet 310′ is pressed or the end portion 313′ of the shaft portion 312′ is riveted, defects, such as bending of or damage to the exposed portion of the shaft portion 312′, may occur.

The first fixing body 211′ to the third fixing body 213′ of the second boss portion 210′ may have a rectangular shape corresponding to the support body 111′ of the first boss portion 110′.

A first coupling hole portion 211′a, a second coupling hole portion 212′a, and a third coupling hole portion 213′a may be formed in the first fixing body 211′, the second fixing body 212′, and the third fixing body 213′, respectively, of the second boss portion 210′ in a direction (X-axis direction of FIG. 5A) of the side edge 101 of the first frame 100′.

The shaft portion 312′ of the rivet 310′ may pass through the first coupling hole portion 211′a of the first fixing body 211′ to the third coupling hole portion 213′a of the third fixing body 211′ in case that the first boss portion 110′ is assembled to the second boss portion 210′.

Referring to FIG. 6, an outer side surface 213′b, which is a coupling surface to which an end portion 313′ of the shaft portion 312′ of the rivet 310′ is riveted, may be formed on an outer side (right side in the X-axis direction of FIG. 6) of the third fixing body 213′.

The outer side surface 213′b of the third fixing body 213′ is a portion where an end portion 313′ of the shaft portion 312′ of the rivet 310′ is riveted to form a riveted portion 313′a having a shape similar to the head portion 311′.

The outer side surface 213′b of the third fixing body 213′ may be inclined downward in a direction (X-axis direction of FIG. 6) in which the shaft portion 312′ of the rivet 310′ passes.

In this regard, an angle α between the outer side surface 213′b of the third fixing body 213′ and a surface of the second frame 200′ on which the first frame 100′ is seated may be 45 degrees or more.

In case that the angle α between the outer side surface 213′b of the third fixing body 213′ and the surface of the second frame 200′ is less than 45 degrees, the riveted portion 313′a may undergo shear fracture because a force acting in a vertical direction (Z-axis direction of FIG. 6) is greater than a force acting in an axial direction (X-axis direction of FIG. 6) of the shaft portion 312′.

Therefore, the angle α between the outer side surface 213′b of the third fixing body 213′ and the surface of the second frame 200′ may be set to 45 degrees or more, so that the force acting on the riveted portion 313′a in the axial direction (X-axis direction of FIG. 6) of the shaft portion 312′ is greater than the force acting on the riveted portion 313′a in the vertical direction (Z-axis direction of FIG. 6).

Hereinafter, an assembly process for a battery frame, according to another embodiment of the disclosure, will be described in further detail.

Referring to FIG. 5A, the first frame 100′ may be arranged on the second frame 200′ so that the first boss portion 110′ is positioned on the second boss portion 210′.

In this regard, the support body 111′ of the first boss portion 110′ may be inserted between the first fixing body 211′ and the second fixing body 212′ of the second boss portion 210′ and be in close contact with and supported by the first fixing body 211′ and the second fixing body 212′.

The insertion hole portion 111′a may be formed in the support body 111′ of the first boss portion 110′ in a direction (X-axis direction) of a side edge of the first frame 100′.

The first coupling hole portion 211′a to the third coupling hole portion 213′a may be formed in the first fixing body 211′ to the third fixing body 213′, respectively, of the second boss portion 210′ in the direction (X-axis direction) of the side edge of the first frame 100′.

In this regard, the first coupling hole portion 211′a to the third coupling hole portion 213′a may also be positioned in a straight line in the axial direction (X-axis direction) of the shaft portion 312′ so that the shaft portion 312′ (see FIG. 5C) of the rivet 310′ (see FIG. 5C) passes through the first coupling hole portion 211′a to the third coupling hole portion 213′a.

Referring to FIG. 5B, the first frame 100′ in which the battery cells 150 are mounted may be seated on the second frame 200′ in a vertical direction (Z-axis direction).

In this regard, opposite sides of the support body 111′ of the first boss portion 110′ may be in close contact with the first fixing body 211′ and the second fixing body 212′ of the second boss portion 210′.

In this state, the insertion hole portion 111′a of the support body 111′ may be in communication with the first coupling hole portion 211′a of the first fixing body 211′ and the second coupling hole portion 212′a of the second fixing body 212′.

In other embodiments, a cut section CS through which the shaft portion 312′ (see FIG. 5C) of the rivet 310′ (see FIG. 5C) is exposed may be formed between the second fixing body 212′ and the third fixing body 213′.

Referring to FIG. 5C, the shaft portion 312′ of the rivet 310′ is sequentially inserted into the first coupling hole portion 211′a of the first fixing body 211′, the insertion hole portion 111′a of the support body 111′, the second coupling hole portion 212′a of the second fixing body 212′, and the third coupling hole portion 213′a of the third fixing body 213′.

In this regard, the head portion 311′ of the rivet 310′ may be seated and supported on the outer side surface of the first fixing body 211′, and the end portion 313′ of the shaft portion 312′ of the rivet 310′ may protrude outward from the outer side surface 213′b of the third fixing body 213′.

The outer side surface 213′b of the third fixing body 213′ may be inclined downward in a direction (X-axis direction of FIG. 6) in which the shaft portion 312′ of the rivet 310′ passes, and an angle α between the outer side surface 213′b of the third fixing body 213′ and a surface of the second frame 200′ on which the first frame 100′ is seated may be 45 degrees or more.

Referring to FIG. 5D, the first boss portion 110′ may be fixed to the second boss portion 210′ by riveting the end portion 313′ of the shaft portion 312′ of the rivet 310′, the end portion 313′ protruding outward from the outer side surface 213′b of the third fixing body 213′.

In this regard, the end portion 313′ of the shaft portion 312′ of the rivet 310′ may be riveted to form a riveted portion 313′a having a shape similar to the head portion 311′, and a portion of the shaft portion 312′ of the rivet 310′ may be exposed through the cut section CS, which is a space between the second fixing body 212′ and the third fixing body 213′.

Therefore, after assembling the first frame 100′ and the second frame 200′, in case that the exposed portion of the shaft portion 312′ is cut and the rivet 310′ is removed, the first frame 100′ may be separated from the second frame 200′, thus being in a disassembled state.

According to one or more embodiments, even in case that the thickness of frames decreases to accommodate the slimming of battery cells, the frames may be easily and accurately assembled.

According to one or more embodiments, after assembly, separation between frames may be performed easily and conveniently.

However, the effects obtainable through the disclosure are not limited to the effects described above, and other unmentioned technical effects will be clearly understood by those of ordinary skill in the art from the description of the disclosure described below.

While the disclosure has been described with reference to specific embodiments and drawings, the disclosure is not limited thereto and it will be apparent to those of ordinary skill in the art that various modifications and changes can be made within the technical spirit of the disclosure and the equivalent scope of the following claims.

What is claimed is:

1. An assembly structure of a battery frame, the assembly structure comprising:
a first boss portion protruding from a side edge of a first frame in which a battery cell is mounted and having an insertion hole portion formed in a direction of the side edge;
a second boss portion arranged to correspond to the first boss portion on a second frame on which the first frame is seated, and having a coupling hole portion corresponding to the insertion hole portion; and
a fastening member having a shaft portion passing through the insertion hole portion and the coupling hole portion, wherein an end portion of the shaft portion is fixed.

2. The assembly structure of claim 1, wherein
the second boss portion comprises:
a first fixing body that is in close contact with and supports the first boss portion and has a first coupling hole portion; and
a second fixing body spaced apart from the first fixing body in an axial direction of the shaft portion and having a second coupling hole portion,
wherein a cut section is formed between the first fixing body and the second fixing body, the cut section exposing a portion of the shaft portion to an outside.

3. The assembly structure of claim 2, wherein
the first boss portion comprises:
a first support body that is arranged in the cut section, has a first insertion hole portion, and is in close contact with the first fixing body; and
a second support body that is arranged in the cut section, has a second insertion hole portion, and is in close contact with the second fixing body.

4. The assembly structure of claim 3, wherein
a distance between the first support body and the second support body is set to a size of 1 to 2 times a diameter of the shaft portion.

5. The assembly structure of claim 1, wherein
an outer side surface of the second fixing body is inclined downward, an end portion of the shaft portion being fixed to the outer side surface of the second fixing body.

6. The assembly structure of claim 5, wherein
an angle between the outer side surface and a surface of the second frame on which the first frame is seated is set to 45 degrees or more.

7. The assembly structure of claim 1, wherein
a height of the first boss portion is set to a size of 2 to 3 times a diameter of the shaft portion.

8. The assembly structure of claim 1, wherein
a protrusion length of the first boss portion is set to a size of 2 to 3 times a diameter of the shaft portion.

9. The assembly structure of claim 1, wherein
the second boss portion comprises:
a first fixing body that is in close contact with and supports one side surface of the first boss portion;
a second fixing body that is in close contact with and supports another side surface of the first boss portion; and
a third fixing body spaced apart from the second fixing body in an axial direction of the shaft portion,
wherein a cut section is formed between the second fixing body and the third fixing body, the cut section exposing a portion of the shaft portion to an outside.

10. The assembly structure of claim 9, wherein
a distance between the second fixing body and the third fixing body is set to 2 times or less a diameter of the shaft portion.

11. A battery package comprising:
at least one battery cell;
a first frame having the at least one battery cell mounted therein and comprising a first boss portion protruding from a side edge thereof, the first boss portion having an insertion hole portion formed in a direction of the side edge; and
a second frame on which the first frame is seated and which comprises a second boss portion corresponding to the first boss portion, the second boss portion having a coupling hole portion formed to correspond to the insertion hole portion,
wherein a shaft portion of a fastening member passes through the insertion hole portion and the coupling hole portion and an end portion of the shaft portion is fixed, to assemble the first frame to the second frame.

12. The battery package of claim 11, wherein
the second boss portion comprises:
a first fixing body that is in close contact with and supports the first boss portion and has a first coupling hole portion; and
a second fixing body spaced apart from the first fixing body in an axial direction of the shaft portion and having a second coupling hole portion,
wherein a cut section is formed between the first fixing body and the second fixing body, the cut section exposing a portion of the shaft portion to an outside.

13. The battery package of claim 12, wherein
the first boss portion comprises:
a first support body that is arranged in the cut section, has a first insertion hole portion, and is in close contact with the first fixing body; and
a second support body that is arranged in the cut section, has a second insertion hole portion, and is in close contact with the second fixing body.

14. The battery package of claim 13, wherein
a distance between the first support body and the second support body is set to a size of 1 to 2 times a diameter of the shaft portion.

15. The battery package of claim 11, wherein
an outer side surface of the second fixing body is inclined downward, an end portion of the shaft portion being fixed to the outer side surface of the second fixing body.

16. The battery package of claim 15, wherein
an angle between the outer side surface and a surface of the second frame on which the first frame is seated is set to 45 degrees or more.

17. The battery package of claim 11, wherein
a height of the first boss portion is set to a size of 2 to 3 times a diameter of the shaft portion.

18. The battery package of claim 11, wherein
a protrusion length of the first boss portion is set to a size of 2 to 3 times a diameter of the shaft portion.

19. The battery package of claim 11, wherein
the second boss portion comprises:
a first fixing body that is in close contact with and supports one side surface of the first boss portion;
a second fixing body that is in close contact with and supports another side surface of the first boss portion; and
a third fixing body spaced apart from the second fixing body in an axial direction of the shaft portion,
wherein a cut section is formed between the second fixing body and the third fixing body, the cut section exposing a portion of the shaft portion to an outside.

20. The battery package of claim 19, wherein
a distance between the second fixing body and the third fixing body is set to 2 times or less a diameter of the shaft portion.
